(19) United States
(12) Patent Application Publication
(10) Pub. No.: US 2009/0163176 A1
(43) Pub. Date: Jun. 25, 2009

(54) NETWORK CONNECTION METHOD OF NON-PORTABLE TERMINAL USING USER IDENTIFICATION INFORMATION OF TERMINAL

(76) Inventor: Atsushi HASEGAWA, Tokyo (JP)

Correspondence Address: MATTINGLY & MALUR, P.C., 1800 DIAGONAL ROAD, SUITE 370, ALEXANDRIA, VA, 22314, US

(21) Appl. No.: 12/336,040

(22) Filed: Dec. 16, 2008

(30) Foreign Application Priority Data
Dec. 20, 2007 (JP) 2007-328136

(51) Int. Cl. H04M 1/66

(52) U.S. Cl. 455/411

(57) ABSTRACT

The mobile terminal and the linked terminal have independent communication access paths to connect to a common network. The mobile terminal and the linked terminal are brought within a short distance from each other for communication so as to transfer user identification information for authentication stored in the mobile terminal to the linked terminal. The long-term shared private key is not transferred in order to realize a high level of security for the non-mobile terminal network connection method.

### INCORPORATION BY REFERENCE

The present application claims priority from Japanese application JP2007-328136 filed on Dec. 20, 2007, the content of which is hereby incorporated by reference into this application.

### BACKGROUND OF THE INVENTION

The present invention relates to a technology to connect a terminal having no user identification information to a network that requires a terminal user authentication. More specifically, the invention relates to a safe, convenient method of authenticating a terminal when the terminal connects to an IMS (IP Multimedia Subsystem) network defined by 3GPP (Third Generation Partnership Project) and 3GPP2 (Third Generation Partnership Project 2), mobile phone standardization organizations.

The third generation (3G) network for mobile phones is a technology that seeks to consolidate two paradigms of the mobile phone network and the Internet. The IMS (IP Multimedia Subsystem) technology is a key to a 3G architecture that realizes ubiquitous wireless access to whatever service the Internet provides. The standardization of the IMS is under way by the standardization organization 3GPP (Third Generation Partnership Project) and 3GPP2 (Third Generation Partnership Project 2). The IMS is designed to be able to operate also when an access path leading to nodes making up the system is not a mobile phone network, and is adopted by the Next Generation Network (NGN) that aims to integrate the fixed telephone network and the broadband access network such as ADSL.

Mounting the IMS on the NGN allow the same method as used in the mobile phone to be performed in the subscriber identification and authentication for other devices than mobile phones, such as fixed line telephones and personal computers (PCs), providing telecommunications carriers with merits in building a system. The use of the IMS also offers subscribers such merits as being able to unify contracts of mobile phone and fixed line phone and to seamlessly receive services from carriers through internet access using mobile phones and PCs. The IMS as defined by GPP/3GPP2 uses an IC card called UICC (Universal Integrated Circuit Card) mounted in a terminal to authenticate the subscriber using the 3G mobile phone terminal. The authentication of a subscriber is done based on a long-term shared private key stored in both the authenticating IMS system and the terminal IC card (3GPP TS 24.228, 3GPP TS 33.102, 3GPP TS 33.102).

On the other hand, to solve a problem of being unable to provide users with multimedia content with satisfactory quality because of limitations on the processing capability, memory capacity and display size of the mobile phone terminal, a proposal is being made to improve convenience for the users in viewing multimedia content by linking the mobile phone terminals to relatively sophisticated terminals such as PCs (JP-A-2002-358260).

### SUMMARY OF THE INVENTION

When a user using a terminal with no user identification information attempts to connect to a network that requires authentication, the user needs to enter information necessary for authentication into the terminal by some means. Take for example a situation where the user wishes to use a mobile phone when he is out but, at home, use a fixed phone. Because the authentication of a terminal in the IMS (IP Multimedia Subsystem) requires a loading into the terminal of an IC card, when the user wants to use other terminal temporarily he or she needs to move the IC card into the second terminal he is going to use in order to make the system recognize that the user of that terminal is the same subscriber of the first terminal. This is inconvenient. This invention solves this first problem by obviating the need to move the IC card from one terminal to another.

Consider a case of moving an IC card into a device installed in a place away from the user's office. There is a security problem here, such as the long-term shared private key stored in the IC card being illicitly stolen and recorded into other terminals. This invention solves this second problem by eliminating the step of moving the IC card to keep the long-term shared private key secret from other terminals. Further, when the user wishes to play in other device a multimedia content that cannot be played in a mobile phone, a method such as described in JP-A-2002-358260 may be used. However, when a content provider attempts to offer a service that requires identification of a subscriber, such as when delivering a “content that can only be viewed when the mobile phone subscriber has a contract for that service, this cannot be realized with the method of JP-A-2002-358260. This invention solves this third problem by transferring user identification information to other devices to enable a content provider to identify a subscriber.

This invention provides a means which enables a linked terminal not having user identification information to work as a mobile terminal by transferring the user identification information of the mobile terminal to the separate linked terminal.

A linked terminal connected to an authentication device having user identification information and to a user authentication server is provided. The linked terminal comprises: a first communication interface to communicate with the authentication device; a second communication interface to communicate with the user authentication server; and a program execution unit; wherein when it receives a first message including the user identification information from the authentication device through the first communication interface, the program execution unit retrieves the user identification information from the first message and sends a second message including the user identification information to the user authentication server through the second communication interface; wherein when it receives a third message including a parameter generated by the user authentication server from the user authentication server through the second communication interface, the program execution unit sends to the authentication device through the first communication interface a message requesting the authentication device to process the parameter by using a private key shared by the authentication device and the user authentication server.

Because the linked terminal can be made to work as a mobile terminal without transferring an IC card, the user of the mobile terminal can use other terminals more easily than in the case with conventional terminals. By preventing illicit reading of a private shared key, public terminal facilities at places away from office can be used with high level of security. Further, since the system side recognizes the user of a public terminal to be the same subscriber of the mobile terminal, the public terminal can be used with the subscriber contract state of the mobile terminal made available to the public terminal. The system side does not need to have a dedicated function to authenticate terminals other than the mobile terminal, assuring an effective use of facilities of a system holder.

### BRIEF DESCRIPTION OF THE DRAWINGS

FIG. 1 illustrates an example of an overall system configuration including the IMS system.

FIG. 2 illustrates an example of configuration of a mobile terminal 100.

FIG. 3 illustrates an example of configuration of a linked terminal 200.

FIG. 4 shows information recorded in an IC card 112.

FIG. 5 shows a main flow of processing executed by a communication program 113 recorded in a memory 107 of the mobile terminal 100 and by a communication program 213 recorded in a memory 207 of the linked terminal 200.

FIG. 6 is an example of processing flow of communication start subroutines (1001, 2001) performed by the communication program 113 and the communication program 213.

FIG. 7 is an example of processing flow of ID transfer subroutines (1002, 2002) performed by the communication program 113 and the communication program 213.

FIG. 8 is an example of processing flow of authentication calculation subroutines (1003, 2004) performed by the communication program 113 and the communication program 213.

FIG. 9 is an example of processing flow of communication termination subroutines (1003, 2004) performed by the communication program 113 and the communication program 213.

FIG. 10 is an example of a sequence diagram showing an IMS registration operation defined by 3GPP TS 24.228.

FIG. 11 is an example of a sequence diagram subsequent to FIG. 10, showing the IMS registration operation defined by 3GPP TS 24.228.

FIG. 12 is an example of a sequence diagram showing a content download operation using a linked terminal after the IMS registration operation.

FIG. 13 illustrates an example of an overall system configuration including the IMS system according to a second embodiment.

FIG. 14 is an example of a sequence diagram showing an IMS registration operation in the second embodiment.

FIG. 15 is an example of a sequence diagram subsequent to FIG. 13, showing the IMS registration operation in the second embodiment.

FIG. 16 shows an example of application of this invention.

### DETAILED DESCRIPTION OF THE INVENTION

Embodiments of this invention will be described by referring to the accompanying drawings.

### Embodiment 1

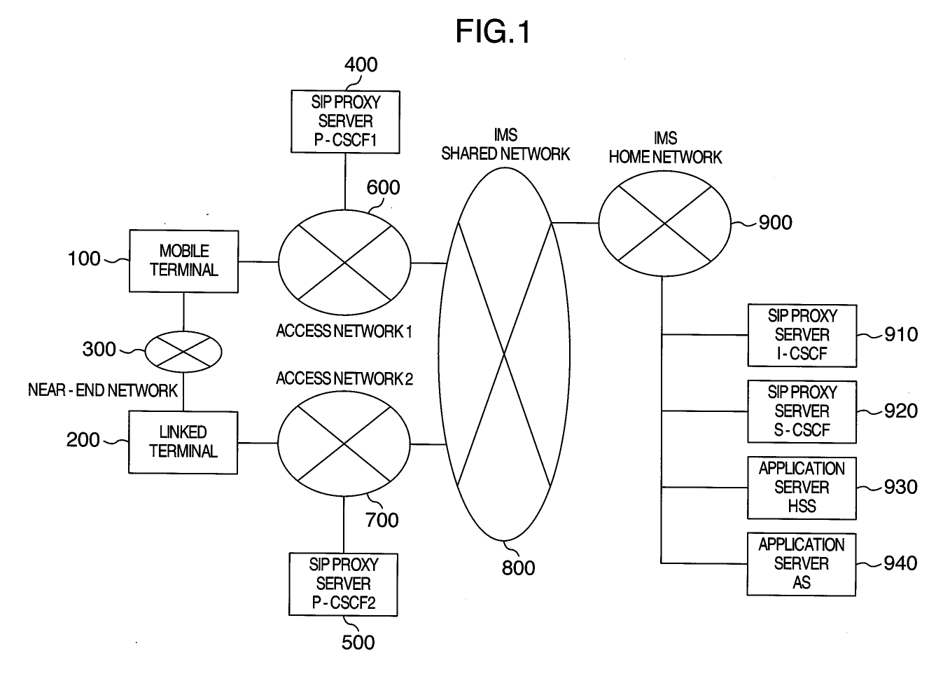

FIG. 1 shows an example of an overall system configuration including the IMS (IP Multimedia Subsystem). A mobile terminal 100 mounts an IC (Integrated Circuit) card and a linked terminal 200 links with the mobile terminal 100. A near-end communication network 300 is used to connect the mobile terminal 100 and the linked terminal 200. There are no limitations on topology and architecture of the network. In this embodiment a direct connection by means of USB (Universal Serial Bus)-mobile phone connector or a wireless connection (Bluetooth, etc.) is contemplated to implement the system.

An SIP proxy server P-CSCF1 (Proxy-Call/Session Control Function) 400 is connected to an access network 600 to which the mobile terminal 100 is connected. The proxy server has a function defined by the 3GPP (Third Generation Partnership Project) and 3GPP2 (Third Generation Partnership Project 2). The P-CSCF1 400 is allocated to the user at time of user registration and is connected to the user through the access network. Communication with the user terminal after authentication is carried out under IPsec. The P-CSCF1 400 directly sends and receives a request for SIP (Session Initiation Protocol) with the mobile terminal 100. An SIP proxy server P-CSCF2 500 is connected to an access network 700 to which the linked terminal 200 is connected. The P-CSCF2 500 has a function defined by the 3GPP/3GPP2. The P-CSCF2 500 directly transfers an SIP request to and from the linked terminal 200.

The access network 600 is designed to connect the mobile terminal 100 to an IMS shared network 800 and has no limitations on its topology or architecture. In this embodiment, a GPRS (General Packet Radio Service) in 3G is contemplated for implementation. It is positioned as a roaming network in IMS. The access network 700 working is designed to connect the linked terminal 200 to the IMS shared network 800 and has no limitations on its topology or architecture. In this embodiment, Internet connections (such as dial-up connections, ADSL (Asymmetric Digital Subscriber Line) connections and FTTH (Fiber to The Home) connections) are contemplated. It is positioned as a roaming network. The IMS shared network 800 functioning in IMS is designed to interconnect the access network 600, access network 700 and IMS home network 900 and has no limitations on its topology or architecture. The IMS home network 900 is connected to the IMS shared network 800 and has no limitations on its topology or architecture. The IMS home network 900 is managed by a carrier with which the subscriber using the mobile terminal 100 has signed up, and is connected with nodes from which to provide services to subscribers.

An SIP proxy I-CSCF 910 is connected to the IMS home network 900 and has a function defined by 3GPP/3GPP2. The I-CSCF 910 is included in the IMS home network 900 and identifies an HSS 930 that stores subscriber information of a user who is going to make a registration. Next, upon instruction from the HSS 930, the I-CSCF 910 hands the registration operation over to an S-CSCF 920. It also receives an SIP request transferred from the P-CSCF1 400 connected to the access network 600 and from the P-CSCF2 500 connected to the access network 700. SIP URI (Uniformed Resource Identifier) of the I-CSCF (Interrogating-Call/Session Control Function) is registered with a DNS (Domain Name Server) on the IMS shared network and associated with a domain name of the IMS home network. For this reason, the I-CSCF constitutes a gate for the P-CSCF when it attempts to make a connection to the IMS home network.

The SIP proxy server S-CSCF (Serving-Call/Session Control Function) 920 is connected to the IMS home network 900 and has a function defined by 3GPP/3GPP2. The S-CSCF 920 manages user identification information, profile information of services that subscribers have signed up for, and authentication information. It receives SIP requests transferred from the I-CSCF 910. A particular S-CSCF 920 is assigned to each subscriber and provides the associated services to the assigned subscribers. An application server HSS (Home Subscriber Server) 930 is connected to the IMS home network 900 and has a function defined by 3GPP/3GPP2. It stores all information on subscribers and holds a database on details of contract situations. It communicates with the I-CSCF 910 and S-CSCF 920 under a Diameter protocol (RFC 3588). An application server AS (Application Server) 940 is connected to the IMS home network 900 and has a function defined by 3GPP/3GPP2. It also has applications for providing subscribers with services and an interface with HSS 930.

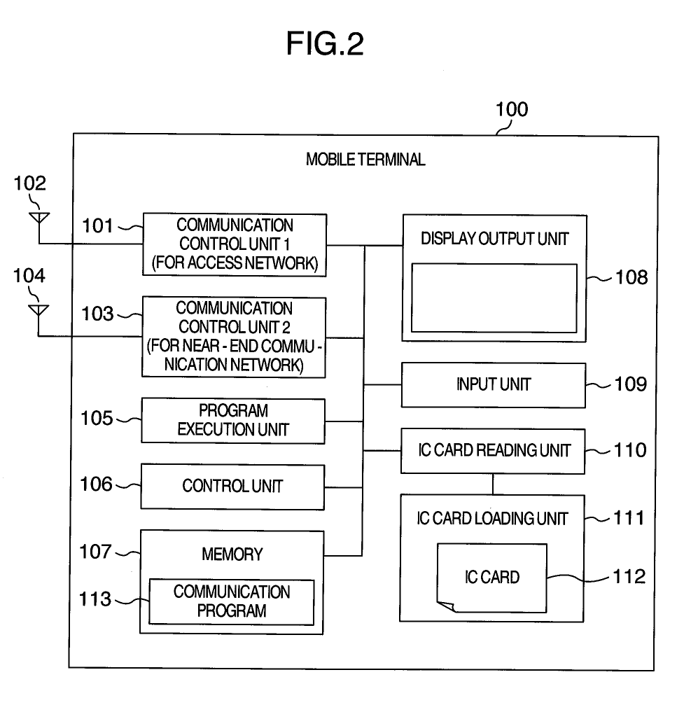

FIG. 2 shows a configuration of the mobile terminal 100. A first communication control unit 101 performs a communication control for connection with the access network 600. An actual processing unit for this control can be mounted in ways similar to those of a 3G (Third Generation) mobile phone terminal. Denoted 102 is a communication interface connected to the communication control unit 101 and which can be mounted in the same way as a transmission and reception antenna of a mobile phone. A second communication control unit 103 performs a communication control to connect to the near-end communication network 300. An actual processing unit for this control can be mounted in the same way as that of a 3G mobile phone terminal. A communication interface 104 is connected to the communication control unit 103 and can be mounted in the same way as an external connector of a mobile phone or a transmission and reception antenna such as Bluetooth. A program execution unit 105 is a processor that executes (or runs) a program stored in memory. It can be implemented with a general-purpose processor such as CPU (Central Processing Unit). A control unit 106 performs an overall control of the entire device, such as managing function units connected to a bus and controlling data transfer timings. A memory 107 stores a communication program 113.

A display output unit 108 is used to display information for the user. This can be realized with a liquid crystal display or the like. An input unit 109 is used by the user to enter a program start instruction or the like. This can be realized with, for instance, a keyboard. An IC card reading unit 110 is a device to read information recorded in an IC card 112 loaded in an IC card loading unit 111. It can be implemented in the same way as a 3G mobile phone terminal. The IC card loading unit 111 accommodates the IC card 112 and connects to the IC card reading unit 110. It can be implemented in the same way as a 3G mobile phone terminal. The IC card 112 is recorded with user identification information defined by 3GPP TS 31.103. It can be implemented in the same way as a 3G mobile phone terminal. The communication program 113 is stored in the memory 107 and describes a procedure to perform an inter-process communication with a communication program 213 mounted in the linked terminal 200.

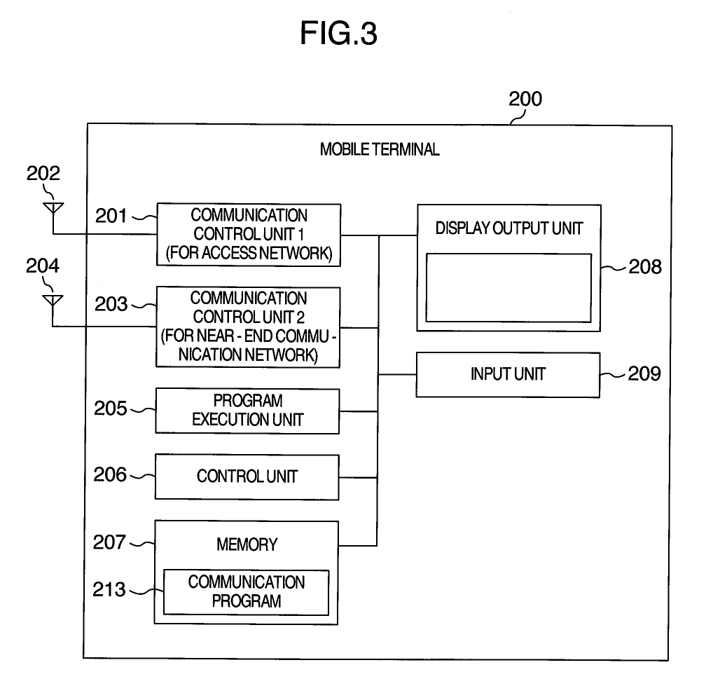

FIG. 3 shows a configuration of the linked terminal 200. A first communication control unit 201 performs a communication control for connection with an access network-2 700. An actual processing unit for this control can be mounted in ways similar to those of a network interface card for personal computers. A communication interface 202 is connected with the first communication control unit 201 and can be mounted in the same way as a network interface connector for personal computers. A second communication control unit 203 performs a communication control to connect to the near-end communication network 300. An actual processing unit for this control can be mounted in the same way as that of a 3G mobile phone terminal. A communication interface 204 is connected to the communication control unit-2 203 and can be mounted in the same was as an external connector of a mobile phone or a transmission and reception antenna such as Bluetooth.

A program execution unit 205 is a processor that executes (or runs) a program stored in memory. It can be implemented with a general-purpose processor such as CPU. A control unit 206 performs an overall control of the entire device, such as managing function units connected to a bus and controlling data transfer timings. A memory 207 stores a communication program 213. A display output unit 208 is used to display information for the user. This can be realized with a liquid crystal display or the like. An input unit 209 is used by the user to enter a program start instruction or the like. This can be realized with a keyboard, for instance. A communication program 213 is stored in the memory 207 and describes a procedure to perform an inter-process communication with the communication program 113 mounted in the mobile terminal 100.

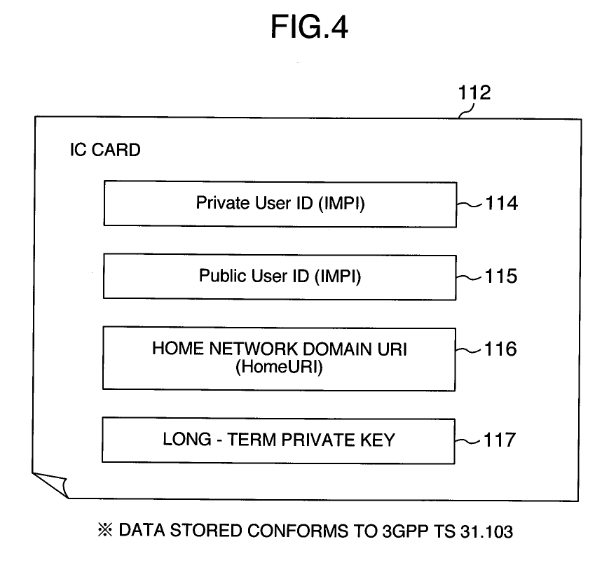

FIG. 4 shows information recorded in the IC card 112. The information to be recorded is defined by 3GPP TS 31.103. All fields (114-117) can only be read and no values in them can be changed by the user. A Private User ID (IMPI) 114 is a SIP URI representing a private user ID assigned to the user. Only one IMPI 114 can be stored in the IC card 112. A Public User ID (IMPU) 115 is an SIP URI representing a public user ID assigned to the user. One or more of IMPUs 115 are stored in the IC card 112. A Home Network Domain URI (Home URI) 116 is an SIP URI including a home network domain. This information is used to search an address of the home network during the IMS registration. Only one Home URI 116 is stored in the IC card 112. A long-term private key (long-term shared private key) 117 is used for authentication and for calculating an integrity assurance key (IK) and an encryption key (CK), both used between the terminal and the network.

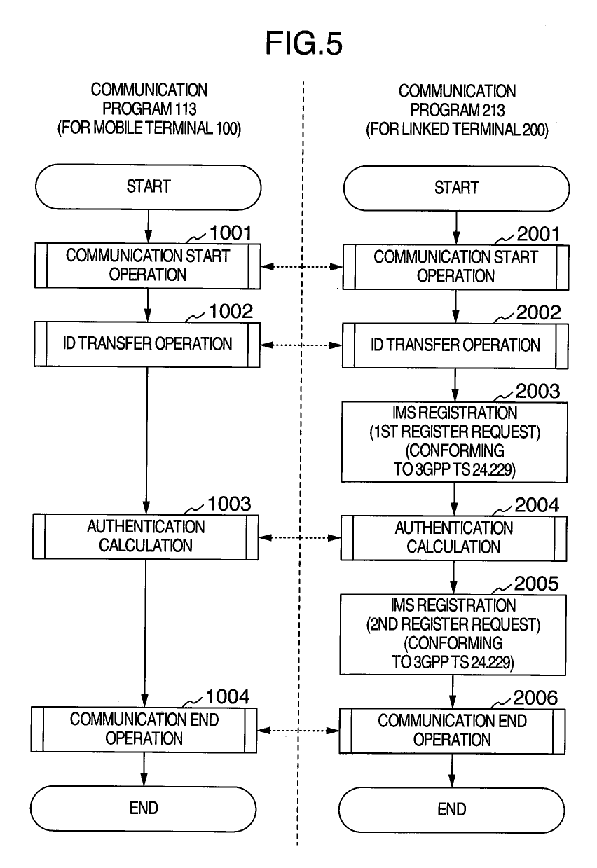

FIG. 5 shows a main flow of processing performed by the communication program 113 stored in the memory 107 of the mobile terminal 100 and by the communication program 213 stored in the memory 207 of the linked terminal 200. First, in both the communication programs 113, 213, a communication start operation (1001, 2001) is initiated to start the communication between the communication programs 113 and 213. Details of the subroutine will be described later. Next, in both the communication programs 113, 213, an ID transfer operation (1002, 2002) is started to transfer the user identification information (ID information) recorded in the IC card 112 loaded in the mobile terminal 100. Details of the subroutine will be described later. Next, in the communication program 213, an IMS registration operation (2003) is started. This is an operation to send a first SIP REGISTER request in the IMS registration operation defined by 3GPP TS 24.229 to P-CSCF2 500. Next, in both the communication programs 113, 213, an authentication calculation operation (1003, 2004) is started. The communication program 213 during the IMS registration operation (2003) uses a parameter received from the P-CSCF2 500 and requests the communication program 113 to generate the authentication information. Details of the subroutine will be described later. Next, in the communication program 213 an IMS registration operation (2005) is started. This is an operation to send a second SIP REGISTER request in the IMS registration operation defined by 3GPP TS 24.229 to P-CSCF2 500. Now, the IMS registration operation is completed. As a last step, in both the communication programs 113, 213, a communication end operation (1004, 2006) is started to end the communication between the programs 113 and 213. Details of the subroutine will be described later.

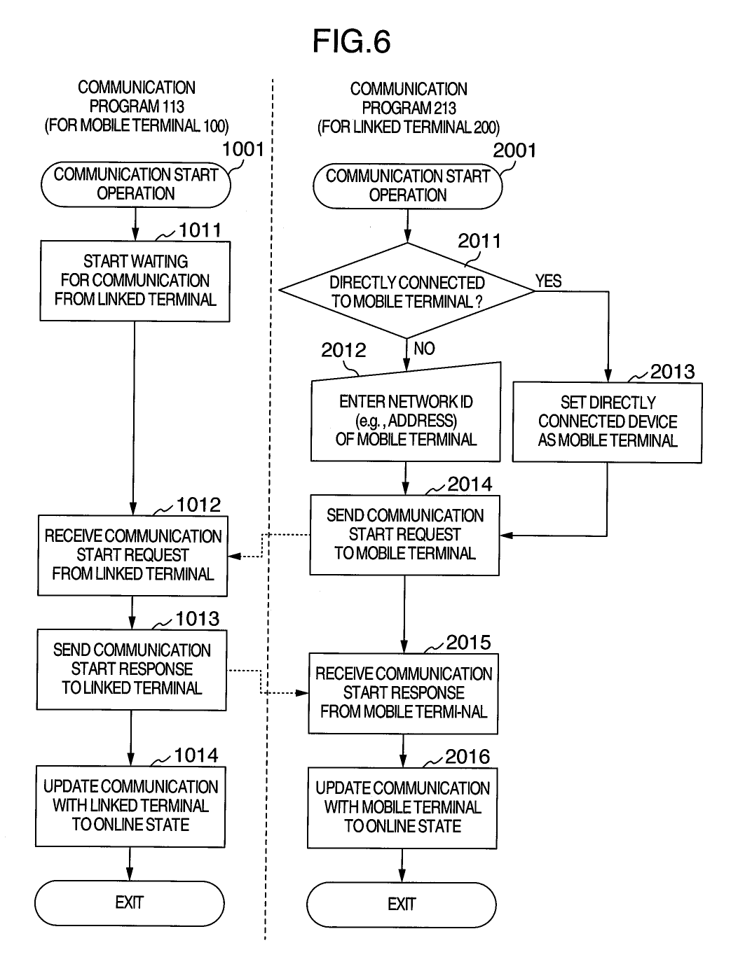

FIG. 6 shows a flow of processing performed by communication start subroutines (1001, 2001) of the communication program 113 and the communication program 213. First, by connecting the mobile terminal 100 and the linked terminal 200 through the near-end communication network 300, or by connecting the mobile terminal 100 and the linked terminal 200 through the near-end communication network 300 and operating from the input unit 209 of the linked terminal 200, the communication program 113 starts waiting for a communication from the linked terminal 200 (1011). At the same time, the communication program 213 retrieves an interface state of itself to see if it is directly connected with the mobile terminal 100 (2011). If the communication program 213 finds itself directly connected with the mobile terminal 100, it sets the mobile terminal 100 as a directly connected device and proceeds to the next step (2013). If the interface state is not the direct connection, the communication program 213 displays on the display output unit 208 a screen in which to input a network ID (such as address) of the mobile terminal 100. Upon receiving an input from the input unit 209, the program 213 sets the input network ID as the mobile terminal 100 before moving to the next step (2012)

Next, the communication program 213 sends a communication start request to the mobile terminal 100 thus set (2014). The communication program 113 receives the communication start request sent from the communication program 213 (1012). Here, the communication program 113 may check if it can connect to the linked terminal 200. In this embodiment, however, this step is omitted. Next, the communication program 113 sends a communication start response to the communication program 213. The communication program 213 receives the communication start response from the communication program 113 (2015). With this reception complete, the communication between the communication programs 113 and 213 is made possible. Next, in both the communication programs 113, 213, their communication state in an internal memory is updated to an online state (1014, 2016) and the communication start subroutine is ended.

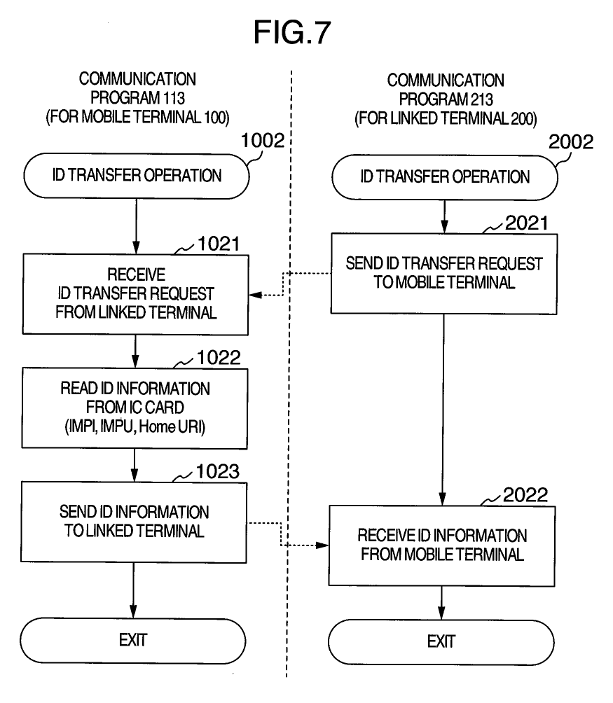

FIG. 7 shows a processing flow of ID transfer subroutines (1002, 2002) of the communication program 113 and the communication program 213. First, the communication program 213 sends an ID transfer request to the communication program 113 (2021). Upon receiving the ID transfer request from the communication program 213, the communication program 113 proceeds to the next step (1021). Next, the communication program 113 issues an ID information read request to its IC card reading unit 110 to read data (1022). Data read here is three pieces of data, IMPI 114, IMPU 115 and Home URI 116. These information is necessary in generating the SIP REGISTER request that the communication program 213 in the operation 2003 sends to P-CSCF2 500. Next, the communication program 113 sends the ID information read by the operation 1022 to the communication program 213 (1023). The communication program 213 receives the ID information from the communication program 113 (2022) and ends the ID transfer subroutine.

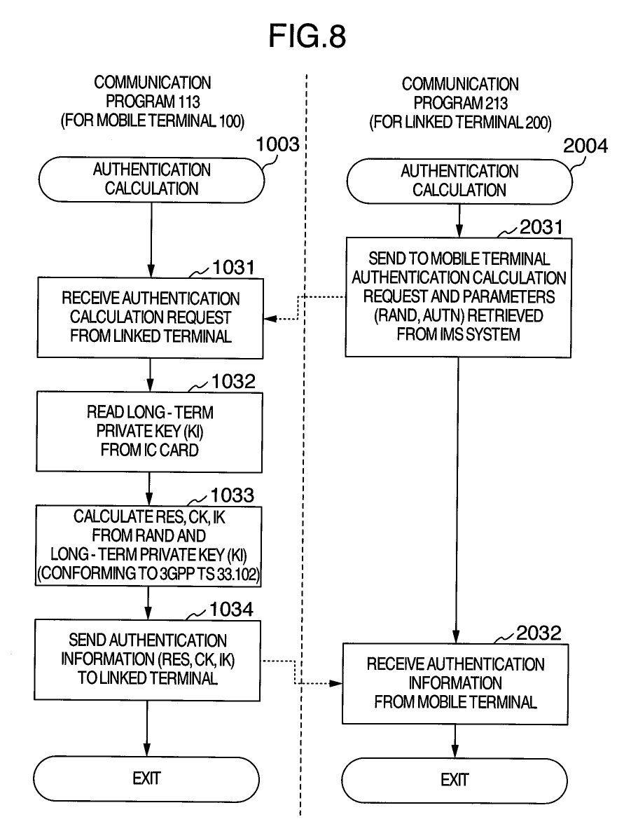

FIG. 8 shows a processing flow of authentication calculation subroutines (1003, 2004) of the communication program 113 and the communication program 213. First, the communication program 213 sends an authentication calculation request to the communication program 113 (2031). At this time, the request includes parameters received from the P-CSCF2 500 as a response to the operation 2003, RAND (random challenge value) and AUTN (network authentication token). Upon receiving the authentication calculation request from the communication program 213, the communication program 113 moves to the next step (1031). Next, the communication program 113 issues a request for reading the long-term private key (KI) 117 to its IC card reading unit 110 to read data (1032).

Next, the communication program 113 calculates the authentication information from the RAND received from the communication program 213 during the operation 1031 and from the long-term private key (KI) 117 read by the operation 1032. The authentication information represents three pieces of information, i.e., RES (response value to the challenge value), CK (session key for encryption) and IK (session key for integrity assurance). The calculation method conforms to the algorithm defined by 3GPP TS 33.102. At this timing, the communication program 113 checks the legitimacy of the network authentication token AUTN to complete the network authentication. Then, the communication program 113 sends the authentication information (RES, CK, IK) calculated by the operation 1023 to the communication program 213 (1034). The communication program 213 receives the authentication information from the communication program 113 and ends the authentication calculation subroutine.

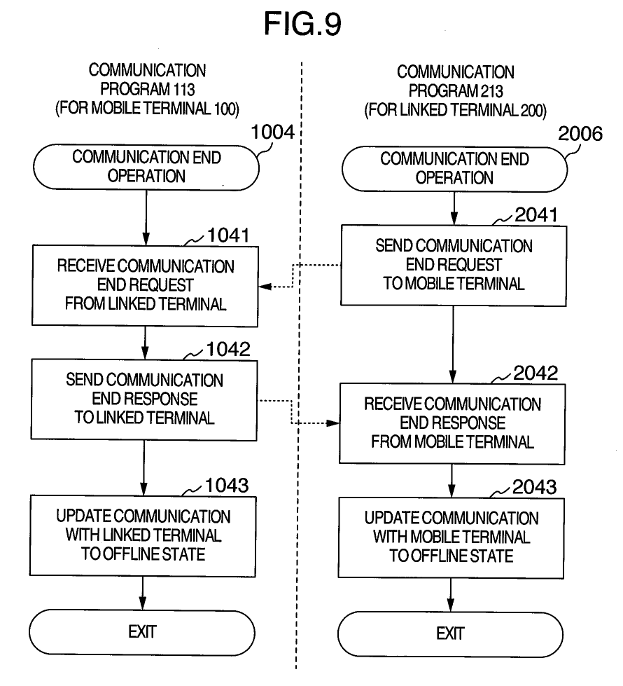

FIG. 9 shows a processing flow of communication end subroutines (1004, 2006) of the communication program 113 and the communication program 213. First, the communication program 213 sends a communication end request to the communication program 113 (2041). The communication program 113 receives the communication end request from the communication program 213 (1041). Next, the communication program 113 sends a communication end response to the communication program 213 (1042). The communication program 213 receives the communication end response from the communication program 113 (2042). With the response received, the communication processing between the communication programs 113 and 213 is completed. Next, both of the communication programs 113, 213 update their communication states to an offline state in the memory 107 (1043, 2043) to end the communication end subroutine.

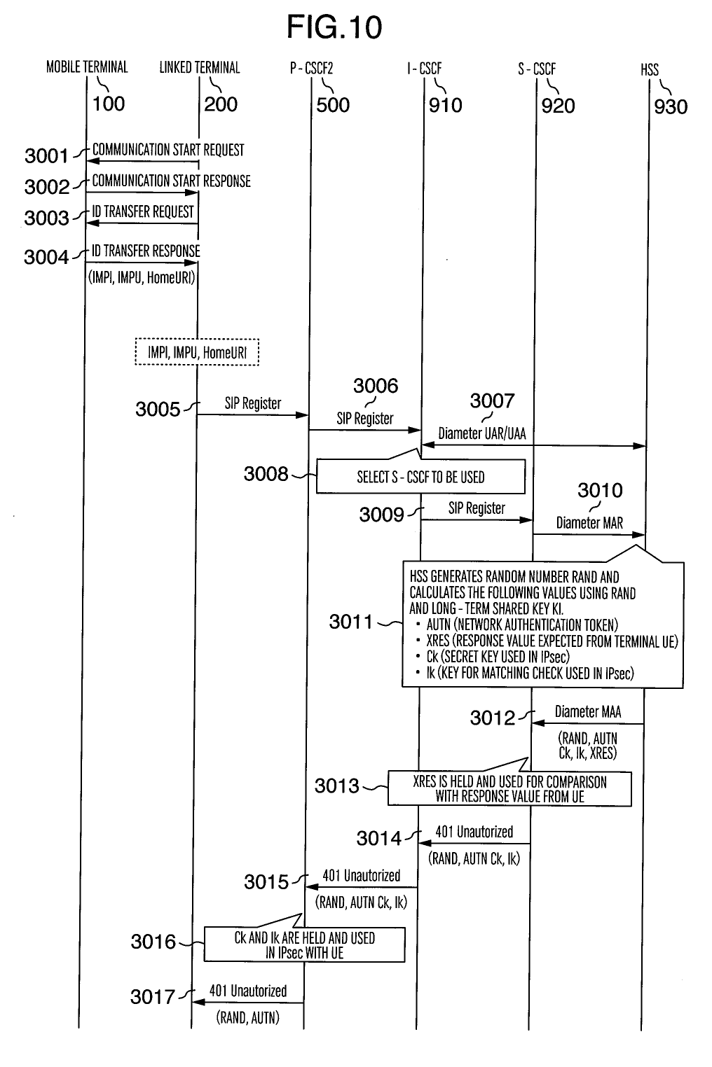

FIG. 10 is a sequence diagram for the IMS registration operation defined by 3GPP TS 24.228. In FIG. 10, vertical lines represent the mobile terminal 100, linked terminal 200, P-CSCF2 500, I-CSCF 910, S-CSCF 920 and HSS 930. In this sequence, the linked terminal 200 operates as a SIP UA (User Agent) and the mobile terminal 100 is concealed from the IMS system node (P-CSCF2 500, I-CSCF 910, S-CSCF 920 and HSS 930). In other words, the linked terminal 200 on the sequence behaves as if it is the mobile terminal 100 loaded with the IC card 112. The communication start request (3001) represents the operations 1012, 2014. The communication start response (3002) represents the operations 1013, 2015. An ID transfer request (3003) represents the operations 1021, 2021. An ID transfer response (3004) represents the operations 1022, 1023, 2022. The transferred ID information (IMPI 114, IMPU 115, Home URI 116) is held in the linked terminal 200.

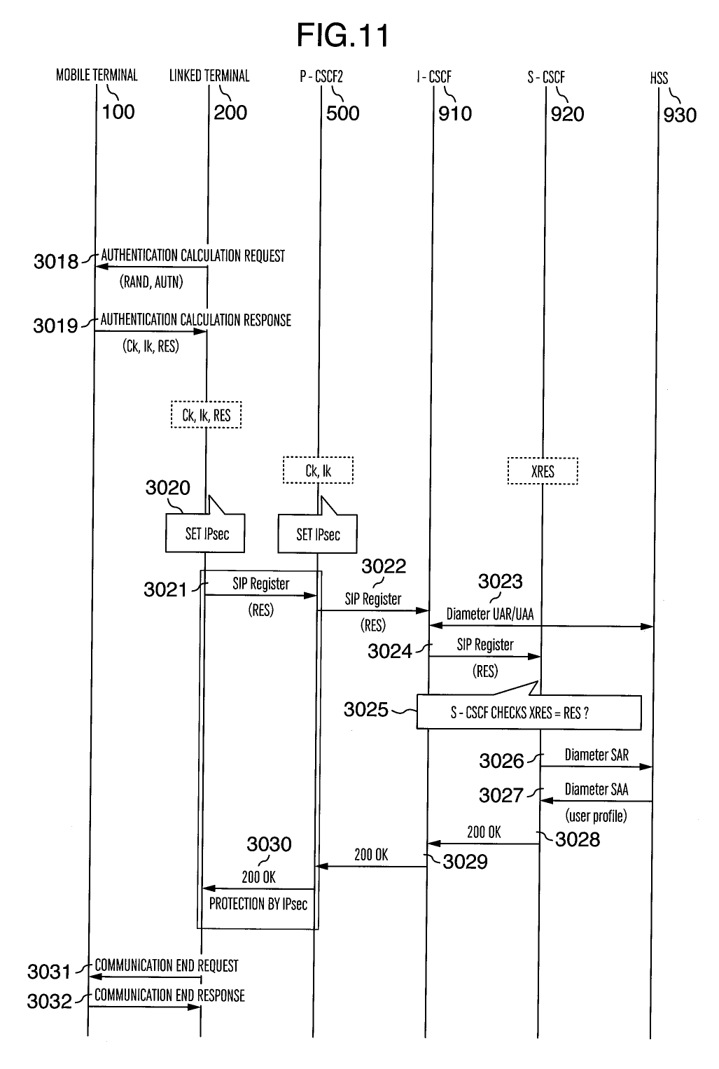

FIG. 11 is a sequence diagram subsequent to FIG. 10 for the IMS registration operation defined by 3GPP TS 24.228. An authentication calculation request (3018) represents the operations 1031, 2031. The authentication calculation response (3019) represents the operations 1032, 1033, 1034, 2032. The transferred authentication information (CK, IK, RES) is held in the linked terminal 200. The communication end request (3031) represents the operations 1041, 2041. The communication end response (3032) represents the operations 1042, 2042.

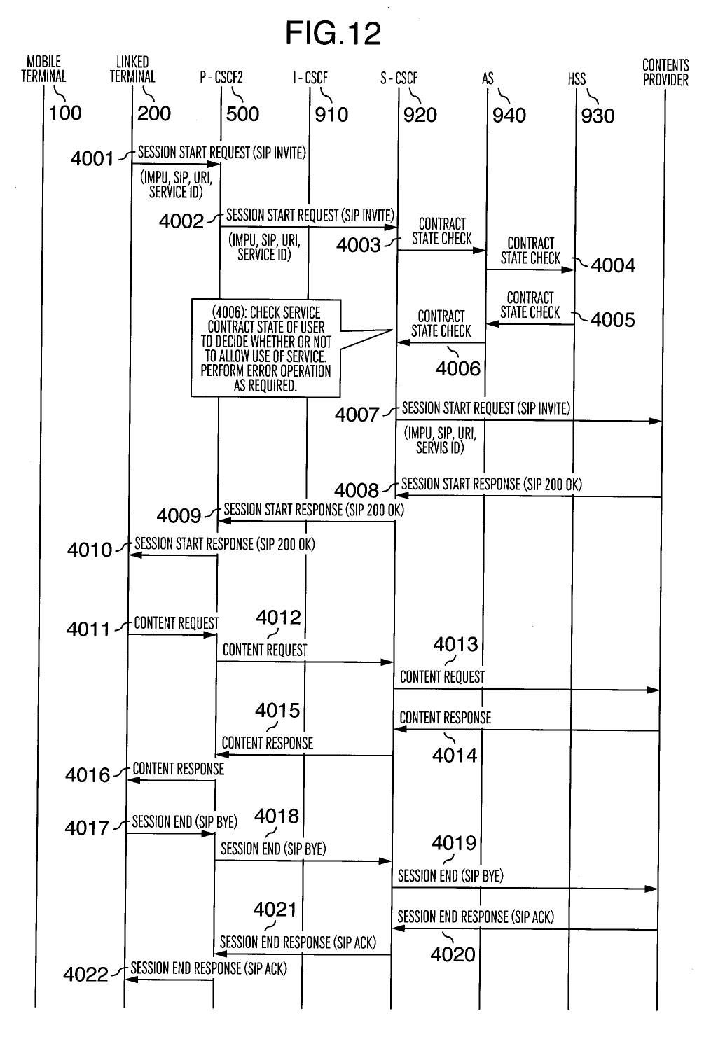

FIG. 12 shows an example of content downloading by the linked terminal 200 following the IMS registration operation. With the IMS registration complete, the IMS system side (P-CSCF2 500, S-CSCF 920, HSS 930, etc.) can decide that the linked terminal 200 is being used by a subscriber of the mobile terminal 100 because the linked terminal 200 is associated with the IMPU 115 of the mobile terminal 100.

In FIG. 12 vertical lines represent the mobile terminal 100, linked terminal 200, P-CSCF2 500, I-CSCF 910, S-CSCF 920, AS 940, HSS 930 and content provider. In the sequence the linked terminal 200 operates as an SIP UA (User Agent). The linked terminal 200 sends a session start request (SIP INVITE request) to the P-CSCF2 500 (4001). The P-CSCF2 500 verifies that a source IP address and the IMPU 116 attached to the request match the information registered in itself, before transferring the SIP INVITE request to the S-CSCF 920 (4002). During the IMS registration, the P-CSCF2 500 transfers the request to the S-CSCF 920 without routing it through the I-CSCF 910 because the IP address of the S-CSCF 920 for the IMPU 115 of interest is notified to the P-CSCF2 500. Next, the S-CSCF 920 uses a conventional technique of filter criteria to determine a transfer destination of the request (4003). In the example of FIG. 12, the S-CSCF 920 transfers the request to an AS (Application Server) 940 for service authentication, by using a service ID attached to the request as a reference.

The AS 940 receives the request transferred from the S-CSCF 920 and checks with the HSS 930 to see if the request transmission source IMPU 115 has made a contract for the service ID attached to the request (4004). Based on the IMPU 115 and the service ID, the HSS 930 searches through its database and returns the search result on the contract situation to the AS 940 (4005). The AS 940 receives the contact situation check result from the HSS 930 and, if there is a contract, sends a response to the S-CSCF 920 to enable it to continue the subsequent operations (4006). If it is found the IMPU has done illicit activities or not signed a contract, the AS 940 sends an error response to the S-CSCF 920. If the contract is found normal, the S-CSCF 920 transfers to the content provider the SIP INVITE request that was transmitted from the linked terminal 200 (4007).

The content provider operates as a SIP UA and issues an SIP 20 OK response (4008). The SIP 200 OK response is sent through the S-CSCF 920 and P-CSCF2 500 to the linked terminal 200 (4009, 4010). When this request arrives at the linked terminal 200, an SIP session is established between the linked terminal 200 and the content provider so that a data transfer can be done. At the start of the normal SIP session, notification of the QoS (Quality of Service) capability and content playback capability and check on the QoS resource allocation are performed in addition to the operations shown in FIG. 12. A series of steps (4011-4016) by which the linked terminal 200 downloads content handles a plurality of request responses until the content download is completed. The procedure (4017-4022) to end the SIP session after the content transfer during the SIP session is complete involves sending a SIP BYE request from the linked terminal 200 to the content provider via the P-CSCF2 500 and the S-CSCF 920. The content provider sends an ACK response to the BYE request to end the SIP session.

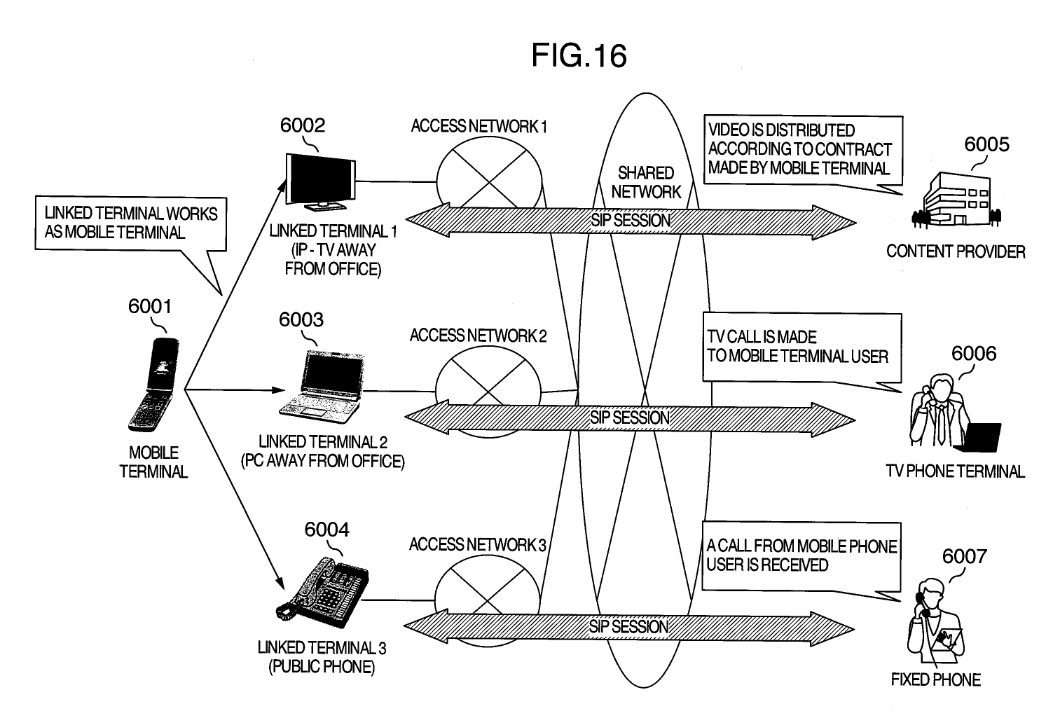

As shown in the example of FIG. 12, after the IMS registration operation is finished, the communication is not performed between the linked terminal 200 and the mobile terminal 100. The linked terminal 200 can by itself alone establish the SIP session or receive services for mobile terminal subscribers from the provider. More detailed applied example of embodiment 1 is shown in FIG. 16. As examples of linked terminal 200 that replaces the mobile terminal 100 are shown IP-TV 6002, PC 6003 and fixed telephone 6004.

In the example of IP-TV 6002 (top tier in FIG. 16), a video that a content provider 6005 offers is delivered on an SIP session between the IP-TV 6002 and content provider 6005 and is displayed on the IP-TV 6002. At this time, the IP-TV 6002, or the linked terminal 200, has the IMPU 115 of the mobile terminal 100. The content provider 6005 can check the IMPU 115 contained in the SIP request or the like to identify the subscriber matched to the IMPU 115 and thereby deliver content according to the service contract signed by the subscriber. In combination with the conventional technique, the above system can realize an online charging on the IMS system, giving rise to a possibility of creating a new business model.

In the example of PC 6003 (middle tier), the PC 6003 is registered on the IMS system as the linked terminal 200. Once registered on the IMS system, a terminal can make calls to and receive calls from other IMS terminals. That is, a SIP session can be transmitted from other IMS terminals to the IMPU 115 (transferred from the mobile terminal 100) of the linked terminal 200, making services feasible, for example, allowing a TV phone terminal 6006 to make a call to the PC 6003 or linked terminal 200 to initiate a TV phone session.

In an example of a public telephone 6004 (bottom tier of FIG. 16), the public telephone 6004 constitutes the linked terminal 200 and is registered on the IMS system. It can make calls, as in the case of PC. This makes a service feasible in which an IMPU 115 is transferred to a wired public telephone 6004 in an area where a radio of the mobile terminal 100 cannot be received, in order to make calls.

This invention has features that the IMPU 115 is transferred between the mobile terminal 100 and the linked terminal 200 through the near-end communication and that the long-term shared private key 117 is not transferred to the linked terminal 200. These features allow for preventing illicit use of the linked terminal 200 as practically as possible. This offers a possibility of the linked terminal 200 being transformed into a public facility, which is important in industrial point of view. If the linked terminal 200 can be made publicly available, the user does not need to hold or carry the linked terminal 200 in the above three situations and can use services by using a public linked terminal 200 away from office, on business trip or outdoors.

If the linked terminal 200 is a public facility, there is a possibility that the linked terminal 200 having the IMPU 115 of the user may be used by other person following the use of that linked terminal 200. To prevent this the IMPU 115 of the linked terminal 200 needs to be disabled. This can be achieved by the user on the linked terminal 200 performing a re-registration operation (according to 3GPP TS 24.228) on the same IMPU 115. This is because when the IMPU 115 is drawn close to the mobile terminal 100 from the linked terminal 200, the contact address of the mobile terminal 100 can be associated with the IMPU 115 by the IMS system while at the same time resetting the association between the contact address of the linked terminal 200 and the IMPU 115.

### Embodiment 2

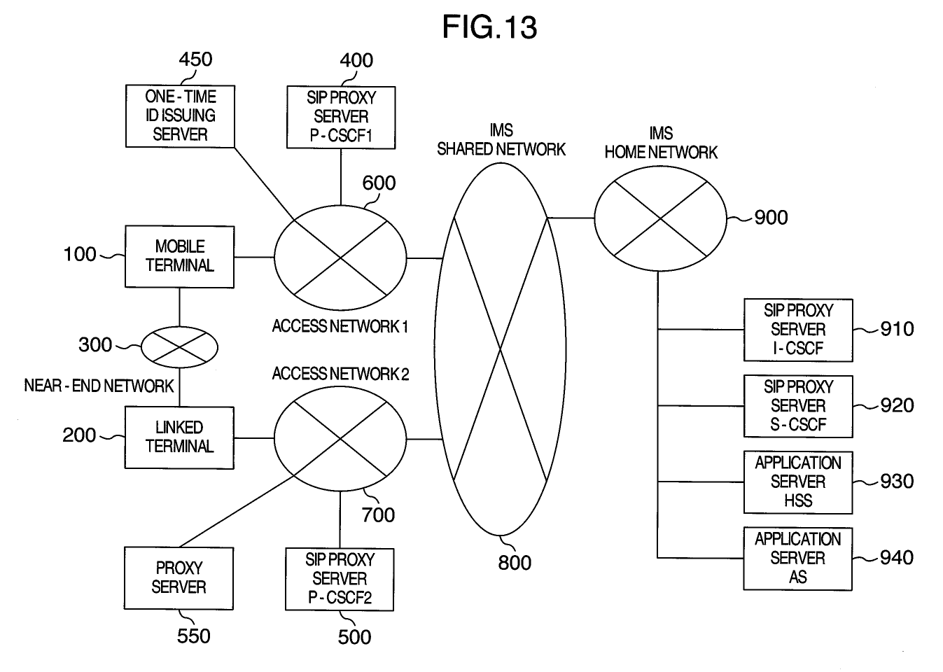

The second embodiment expands embodiment 1 to enhance security. It offers a configuration in which the mobile terminal 100 obtains a disposable user ID in advance so as to keep ID information in the IC card 112 from being disclosed to the linked terminal 200. This embodiment is explained as follows by referring to the drawings. This embodiment, as shown in FIG. 13, includes, in addition to the constitutional elements of embodiment 1, a one-time ID issuing server 450 that issues a disposable one-time ID to the mobile terminal 100 and a proxy server 550 that works as an intermediary when the linked terminal 200 performs an IMS registration operation and during content downloading following the IMS registration operation.

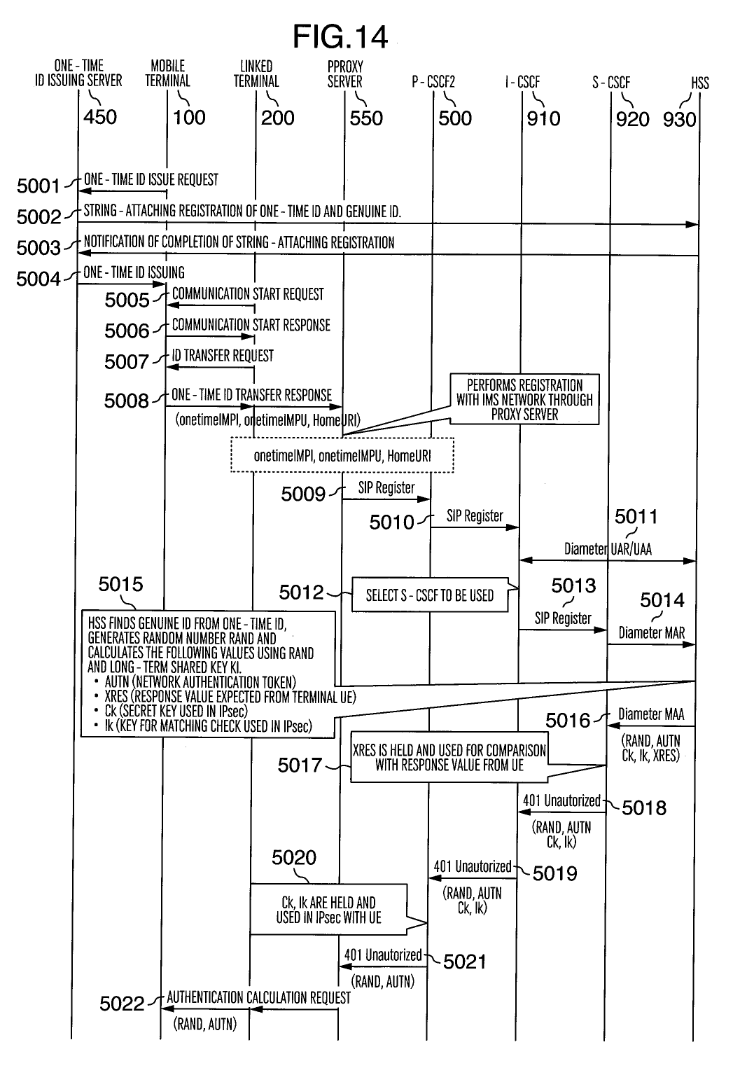

FIG. 14 is a sequence diagram of the IMS registration operation in this embodiment. FIG. 14 shows the one-time ID issuing server 450 and the proxy server 550 added to FIG. 10. The one-time ID issuing server 450 issues one-time ID in response to a one-time ID issue request from the mobile terminal 100. At this time, a plurality of one-time IDs may be issued. By using the one-time ID, the mobile terminal 100 can perform the IMS registration operation with the linked terminal 200 without disclosing a genuine ID (IMPI 114 and IMPU 115). Also, with the linked terminal 200 performing the IMS registration operation and content downloading through the proxy server 550, the proxy server 550 can hold the session, concealing a content distribution source from the linked terminal 200.

The one-time ID issue request (5001) is made by the mobile terminal 100 to the one-time ID issuing server 450 prior to the authentication operation with the linked terminal 200. The one-time ID issuing server 450, upon receiving the one-time ID issue request, performs a string-attaching registration on the HSS 930 to match one or more one-time IDs to a genuine ID (IMPI 114, IMPU 115) of the mobile terminal 100 (5002). After receiving a string-attaching registration acknowledge response (5003), a one-time ID is issued to the mobile terminal 100 (5004). With the above operations performed, a communication start request and a communication start response are transmitted between the mobile terminal 100 and the linked terminal 200, as in FIG. 10 (5005, 5006).

The mobile terminal 100, upon receiving an ID transfer request from the linked terminal 200 (5007), returns the one-time ID transfer request (5008). What the linked terminal 200 receives is only a disposable one-time ID from which the user cannot be identified. So, there is no possibility of the user communication history remaining in the linked terminal 200. The ID transfer request is transferred to the proxy server 550 which instead performs the registration on the IMS network. Unlike embodiment 1, the HSS searches the string-attached genuine ID from the one-time ID (5015). Then, operations similar to those of embodiment 1 are performed. The authentication calculation request (5022) is transmitted from the proxy server 550 to the mobile terminal 100 through the linked terminal 200.

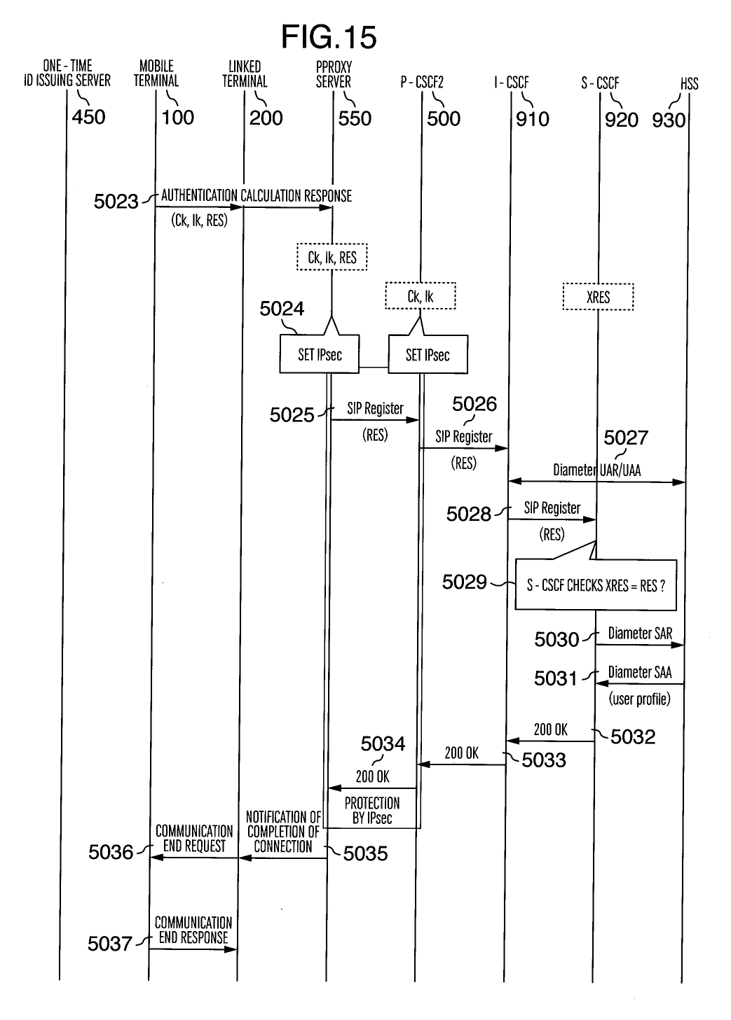

FIG. 15 is a sequence diagram subsequent to FIG. 14. The authentication calculation response (5023) is executed in the same procedure as in embodiment 1. The subsequent operations from SIP Register (5024) to 200 OK (5034) are executed in the same procedure as in FIG. 11. A connection complete notification (5035) informs the linked terminal 200 that the proxy server 550 has completed the IMS registration operation. Upon reception of this notification, the linked terminal 200 transfers a communication end request (5036) and a communication end response (5037) to and from the mobile terminal 100, as in embodiment 1.

The content downloading by the linked terminal 200 following the IMS registration operation is done via the proxy server 550. In this embodiment, when the IMS registration is completed, since the proxy server is associated with the IMPU 115 of the mobile terminal 100, the IMS system side (P-CSCF2 500, S-CSCF920, HSS 930, etc.) can decide that the proxy server 550 is being used by a subscriber of the mobile terminal 100. Unlike embodiment 1, the proxy server 550 is registered with the IMS network to receive services.

When the linked terminal 200 downloads content from a content provider, it makes a content download transfer request to the proxy server 550. This allows the user to safely use unspecified linked terminals 200 on the streets by preventing the linked terminal 200 from having a session. Further, since the proxy server 550 is interposed between the linked terminal 200 and the content provider, a content delivery source can be concealed from the linked terminal 200.

Let us consider a situation where the user away from home wishes to view a video recorded in a home DVD recorder by using a TV or the linked terminal 200 connected to the network. The user downloads the video to the linked terminal 200 from the DVD recorder through a home gateway of his house. At this time, if the proxy server 550 is not interposed between them, there is a possibility of personal information, such as URL of the home gateway, being recorded in the linked terminal 200. By putting the proxy server 550 in between, only the video of a DVD player can be downloaded without revealing URL of a distribution source to the linked terminal 200, thus further enhancing the level of security. Further, a time limit is set for the use of one-time ID to prevent an unauthorized access to services. For example, when the linked terminal 200 illegitimately holds a one-time ID in an attempt to receive service without a permission of the user, an illicit use can be prevented by checking the time limit of use of one-time ID when checking the service contract information with the HSS 930 in FIG. 12 (4004). The operation to receive services can be realized by adding to the operation shown in FIG. 12 the function of checking the time limit of use of the one-time ID with the HSS 930. So, detailed explanation is omitted.

It should be further understood by those skilled in the art that although the foregoing description has been made on embodiments of the invention, the invention is not limited thereto and various changes and modifications may be made without departing from the spirit of the invention and the scope of the appended claims.

1. A linked terminal connected to an authentication device having user identification information and to a user authentication server, the linked terminal comprising:
a first communication interface to communicate with the authentication device;
a second communication interface to communicate with the user authentication server; and
a program execution unit;
wherein when it receives a first message including the user identification information from the authentication device through the first communication interface, the program execution unit retrieves the user identification information from the first message and sends a second message including the user identification information to the user authentication server through the second communication interface;
wherein when it receives a third message including a parameter generated by the user authentication server from the user authentication server through the second communication interface, the program execution unit sends to the authentication device through the first communication interface a message requesting the authentication device to process the parameter by using a private key shared by the authentication device and the user authentication server.

2. A linked terminal according to claim 1, further comprising:
an input interface to accept input operation from a user; and
an output interface to display instructions to the user, processing results and content.

3. An authentication device having a means to store user identification information, comprising:
a communication interface to share a private key with a user authentication server that authenticates a user based on the user identification information and to communicate with a linked terminal connected to the user authentication server through a network; and
a control unit;
wherein when it sends a first message including the user identification information to the linked terminal through the communication interface and receives a second message including a parameter to be processed by the private key from the linked terminal through the communication interface, the control unit sends a result of processing the parameter by the private key to the linked terminal through the communication interface.

4. An authentication device according to claim 3, further comprising:
a memory means to store the user identification information and the private key;
a memory means accommodation unit to accommodate the memory means; and
a memory means reading unit to read the user identification information and the private key stored in the memory means.

5. A user authentication system for authenticating a linked terminal having no user identification information, comprising:
the linked terminal to, when it receives a first message including the user identification information from an authentication device having the user identification information, retrieve the user identification information from the first message and send a second message including the user identification information to the user authentication server;
the user authentication server to, when it receives the second message, send to the linked terminal a third message including a parameter used for authentication by a private key shared with the authentication device; and
the authentication device to, when it receives from the linked terminal a fourth message requesting processing by the private key of the parameter received by the linked terminal, send to the linked terminal a fifth message including a result of processing the parameter by the private key.

6. A user authentication system according to claim 5, wherein the user authentication server manages the user identification information, the private key and a subscribed service profile of a registered user.

7. A user authentication system for authenticating a linked terminal having no user identification information, comprising:
a one-time user identification information issuing server to issue one-time user identification information used for link with the linked terminal;
an authentication device to receive a first message including the one-time user identification information from the one-time user identification information issuing server and send a second message including the one-time user identification information to the linked terminal;
the linked terminal to, when it receives the second message from the authentication device, send a third message including the one-time user identification information to a proxy server;
the proxy server to, when it receives the third message, send a fourth message including the one-time user identification information to the user authentication server, the proxy server being adapted to, when it receives from the user authentication server a fifth message including a parameter used for authentication by a private key shared by the authentication device and the user authentication server, send a sixth message including the parameter to the authentication device through the linked terminal; and
the user authentication server to check a result of processing the parameter by using the private key held in itself.

8. A user authentication system according to claim 7, wherein the one-time user identification information issuing server, when it receives a one-time user identification information issue request from the authentication device, issues the one-time user identification information, relates the one-time user identification information and the user identification information that the authentication device has, and registers them with the user authentication server.

9. A user authentication system according to claim 7, wherein the authentication device sends a one-time user identification information issue request to the one-time user identification information issuing server and, when it receives the one-time user identification information from the one-time user identification information issuing server, stores the one-time user identification information in a memory means.

10. An authentication device according to claim 9, further comprising:
the memory means to store the user identification information and the private key;
a memory means accommodation unit to accommodate the memory means; and
a memory means reading unit to read the user identification information and the private key stored in the memory means.

11. A user authentication system according to claim 7, wherein the linked terminal sends a session start request including the one-time user identification information to the proxy server;
wherein the proxy server retrieves the one-time user identification information from the received session start request and sends a user contract state request including the one-time user identification information to the user authentication server;
wherein when it receives a user contract state response from the user authentication server, the proxy server transfers the session start request to a content delivery server.

12. A user authentication system according to claim 11, wherein, when it receives the session start request from the linked terminal and if the one-time user identification information is within a time limit, the proxy server returns the session start response and transfers a communication from a content server;
wherein, if the one-time user identification information has exceeded the time limit, the proxy server returns an error message.
